(19) United States
(12) Patent Application Publication
(10) Pub. No.: US 2025/0011236 A1
(43) Pub. Date: Jan. 9, 2025

(54) GEOPOLYMER PRODUCTION METHOD

(71) Applicants: Andrey Dudnikov, Woodside, NY (US); Marina Dudnikova, Woodside, NY (US)

(72) Inventors: Andrey Dudnikov, Woodside, NY (US); Marina Dudnikova, Woodside, NY (US)

(21) Appl. No.: 18/411,263

(22) Filed: Jan. 12, 2024

Related U.S. Application Data
(60) Provisional application No. 63/512,379, filed on Jul. 7, 2023.

(51) Int. Cl. C04B 28/00; C04B 14/04; C04B 40/00; C04B 103/10

(52) U.S. Cl. CPC C04B 28/006; C04B 14/045; C04B 40/0046; C04B 2103/10

(57) ABSTRACT

A method of producing a geopolymer product having accelerated setting at a selected point in production includes providing a precursor, a reagent, and an accelerator; mixing the precursor and the reagent to form a geopolymerized binder; adding aggregate to the binder; mixing the aggregate and the binder until a mortar or concrete paste is formed; and applying the mortar or concrete paste. The mortar or paste is applied by extruding, casting, spraying, or brushing. The accelerator is added when providing the precursor; mixing the precursor and the reagent; or applying the mortar or concrete paste. The step selected for adding the accelerator is a function of selecting a setting time for the geopolymer product.

### CROSS-REFERENCE TO RELATED APPLICATION

This application claims the benefit of priority of U.S. provisional application No. 63/512,379, filed Jul. 7, 2023, the contents of which are herein incorporated by reference.

### BACKGROUND OF THE INVENTION

The present invention relates to geopolymers and, more particularly, to a method of producing a geopolymer-based formulation for construction and building materials.

Geopolymer-based mortars, concrete mixes, and other products are favorable for a relatively low environmental impact in the course of their production, such as lowered amounts of carbon dioxide emissions. Such products are useful as building materials and flame-retardant barriers. Geopolymer mortars, concretes, and other products may be dispensed by a three dimensional (3-D) printer, a nozzle, or a hose for example, to create a structure or structural component.

When such a geopolymer is formed, it is subject to a setting time and a hardening time. For instance, when geopolymer precursor is mixed with geopolymer reagent (such as may be done in the preparation), it reacts and makes geopolymer paste. This paste can be molded into any shape due to its plasticity. Within this time, the geopolymer precursor continues to react with the geopolymer reagent and slowly the geopolymer paste or geopolymer binder starts losing its plasticity and starts to harden. This period is often described as the setting time. Hardening time can mean the time that it takes for the geopolymer binder to reach substantial or complete rigidity. Control of setting time and hardening time is of particular importance when the geopolymer material is to be applied or dispensed by a 3-D printer, nozzle, or hose. Current methods allow only a predetermined setting time which cannot be significantly changed during the preparation and application process. Thus, it must be sufficiently long to allow workability of the mix. If the workability time is insufficient, the mix will set inside the system before being applied, making it unusable.

A prior art method of mixing geopolymer mortar or concrete includes mixing a precursor with a reagent or hardener for a period of time dependent upon the type of precursor and the mixing speed until reaction, i.e., geopolymerization, occurs. Aggregate is added and mixed for a time until fully homogenized.

However, presently known methods of controlling setting and hardening time are not sufficient to allow efficient creation of building structures, etc. with a 3-D printer. For instance, in producing geopolymer-based building components with a 3-D printer, the printer traditionally creates the component as a series of relatively thin layers that are compiled on top of one another. It is a requirement in the current art that lower layers must harden before further layers are applied on top of the lower layers. Without a quick hardening of a layer, the 3-D printing process must stop until the lower layer has hardened sufficiently to support another layer being dispensed on top of it. The result is a slow building process.

Existing means of accelerating setting and hardening time for traditional Portland cement mixes are corrosive (highly alkaline and contain chlorides) and cannot be used in a wide range of applications, including geopolymer-based mortars.

As can be seen, there is a need for a geopolymer formulation for quick and efficient production of construction and building components.

### SUMMARY OF THE INVENTION

In one aspect of the present invention, a method of producing a geopolymer product having accelerated setting at a selected point in production comprises providing a precursor, a reagent, and an accelerator; mixing the precursor and the reagent for a first time to form a geopolymerized binder; adding aggregate to the geopolymerized binder; mixing the aggregate and the geopolymerized binder for a second time until a mortar or concrete paste is formed; applying the mortar or concrete paste by a step selected from the group consisting of extruding, casting, spraying, and brushing; and adding the accelerator at a step selected from the group consisting of: providing the precursor; mixing the precursor and the reagent; and applying the mortar or concrete paste; wherein the step selected for adding the accelerator is a function of selecting a setting time for the geopolymer product.

The present disclosure provides precise control of setting times and hardening times over a wide time range as well as novel use of an accelerator for achieving such control.

These and other features, aspects and advantages of the present invention will become better understood with reference to the following drawings, description, and claims.

### BRIEF DESCRIPTION OF THE DRAWINGS

FIG. 1 is a flowchart of an accelerator addition step of preparing a geopolymer product according to an embodiment of the present invention; and

FIG. 2 is a flowchart of a method of preparing a geopolymer product according to an embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a very fluid long-setting geopolymer mix that is accelerated to an almost immediate setting at a predetermined point of the manufacturing process to achieve very fast setting of the mix right after extrusion or application.

In an embodiment, a geopolymer product comprises a precursor, a reagent, and an accelerator. The precursor, reagent, and accelerator form a geopolymer binder, which binder, when mixed with aggregates, forms a mortar or concrete. The time of mixing depends on the type of precursor and the speed of mixing. In an embodiment, the precursor and reagent are mixed for an amount of time until geopolymerization of the mix occurs. Geopolymerization, as used herein, may be the process of the precursor and reagent transforming into a three-dimensional network consisting of covalent bonds. Thereafter, aggregate or aggregates (such as sands or a mix of sands such as quartz sand, feldspar sand, Chamotte sand and others; gravels or mix of gravels such as limestone, granite, basalt, and others; fibers natural and/or synthetic, such as polypropylene, wooden, basalt and others) may be added to the geopolymerized mix. After further mixing for a predetermined period, a mortar or concrete paste is formed.

Thereafter, the accelerator is added to the mix. The setting time is a function of the composition, amount, and the time of introduction of the accelerator. The setting time may range from several seconds to several hours or even days.

The composition and amount of accelerator vary depending on the predetermined setting time and predetermined final structural strength. The amount of accelerator varies depending on the time of addition. The amount that may be added to the precursor or geopolymer binder in fresh state is limited. Addition of too much accelerator at early steps risks blocking the system because of the rate of hardening. The amount of accelerator added at the extrusion step is almost unlimited due to the short time between addition and application.

In some embodiments, the accelerator may be added in a dry form as a powder into a preblended precursor.

In some embodiments, the accelerator may be added in a dry, liquid, slurry, or suspension form into the mix of the reagent and precursor.

In some embodiments, the accelerator may be added into a mortar or concrete in a dry, liquid, suspension, or slurry form.

In some embodiments, the accelerator may be added at a later stage when accelerated hardening is needed, such as during casting of a building component or extrusion of the mixed product from a 3-D printer.

In some embodiments, the accelerator may be added at the very end of the extrusion process, such as at a 3-D printer nozzle (i.e., when all mixing is nearly done and the finished mix is about to be dispensed) by injecting or pumping the accelerator into the mix, or by gravity flow of a slurry or suspension thereof. Subsequently further mixing may be provided by flow of the mix or by high-speed mixing to homogenize the components, thereby achieving a predetermined setting time. This can be accomplished, for example, by feeding the accelerator into the existing mix with an extension delivery mechanism that is securely operatively coupled to the region in which the existing mix has been mixed.

An additional tube or screw conveyor added to the extruder may feed accelerator while the mortar flows in the main tube or screw conveyor. A mixing device may be installed after the main tube and the accelerator tube join. The mixing device may be a high-speed mixer or a gravity mixer. It mixes the mortar with the accelerator at a speed and time effective to fully homogenize the mixture and short enough to avoid blocking of the system due to hardening. The mixed accelerated mortar is then extruded to form the layers of the 3D printed object.

In an embodiment, the precursor comprises an inorganic, amorphous aluminosilicate mineral material or composition, such as fly-ash type F or similar, metakaolin naturally or industrially obtained, naturally calcined caolinitic clay minerals, laterites, ferro-sialates (—Fe—O—Si—O—Al—O—), industrial byproducts such as mine tailings and metallurgical slag, other types of metallurgical by-products, volcanic tuffs (whether calcined or not), silica fumes, microsilica, synthetic or natural zeolites, pumice, pozzolanic materials, mica, muscovite and others or a mix of the preceding items.

In an embodiment, the reagent comprises a silicate of an alkaline metal or an acid.

In an embodiment, the accelerator comprises a mineral origin or a group of minerals. In an exemplary embodiment, the accelerator comprises one or more of gehlenite (Ca2Al(AlSi)O7), akermanite (Ca2MgSi2O7), belite (2CaO*SiO2), alite (3CaO—SiO2), monocalcium aluminate (CaAl2O), and anorthite Ca[Al2Si2O8].

In an embodiment, a method of creating a geopolymer product is provided. The method comprises the steps of mixing a precursor with a reagent until these ingredients undergo geopolymerization, and then adding and mixing an accelerator with the geopolymerized mix just prior to extrusion of the mix of all ingredients before dispensing or extruding the mix of all ingredients to form a structure or object.

Because the accelerator is introduced into the mix just before dispensing or extruding the mixed product, the setting time of the geopolymer product formed herein can be shortened drastically. That is, the problem of setting the mix prior to dispensing or extruding is rendered moot because there is no time for the mix to become set before it is extruded. It will be apparent that setting time can be reduced by increasing the relative concentration of accelerator in the mix. In this fashion, the geopolymer product can set almost immediately, for example after it is extruded from or dispensed by a 3D printer, thus permitting dispensing or extrusion of the geopolymer product as quickly as final mix can be prepared, i.e., without regard to setting time of the final mix.

The disclosure therefore allows preparation of a geopolymer product with a high fluidity and easy pumpability through the pump of a 3D printer application, allowing the 3D printing of structures at an angle of inclination from the vertical, such as arches, domes, sculptures, etc.

The geopolymer material of the present disclosure and the accelerated hardening of the method disclosed herein may be used for example in shotcrete spray application, when the material is extruded with a special device normally used with a sprayed cementitious mortar. It may also be used in oil-well mortars. Moreover, the product and process disclosed herein may be used for various applications, such as sprayed geopolymers for tunnel reinforcement, fire, and corrosion protection; architectural and decorative applications; and repair mortars for airport runways, etc.

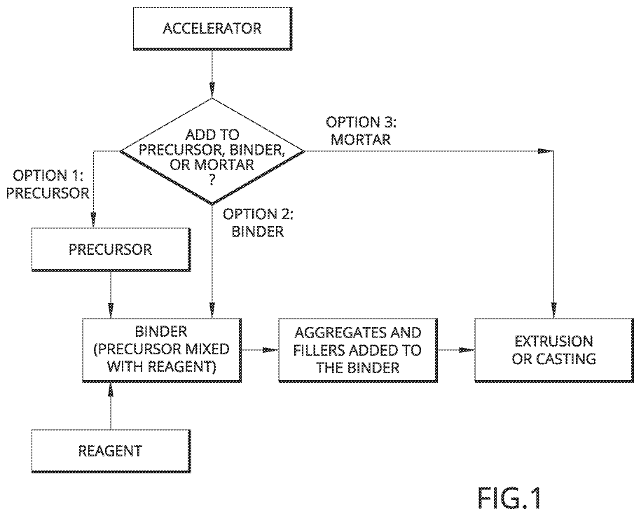

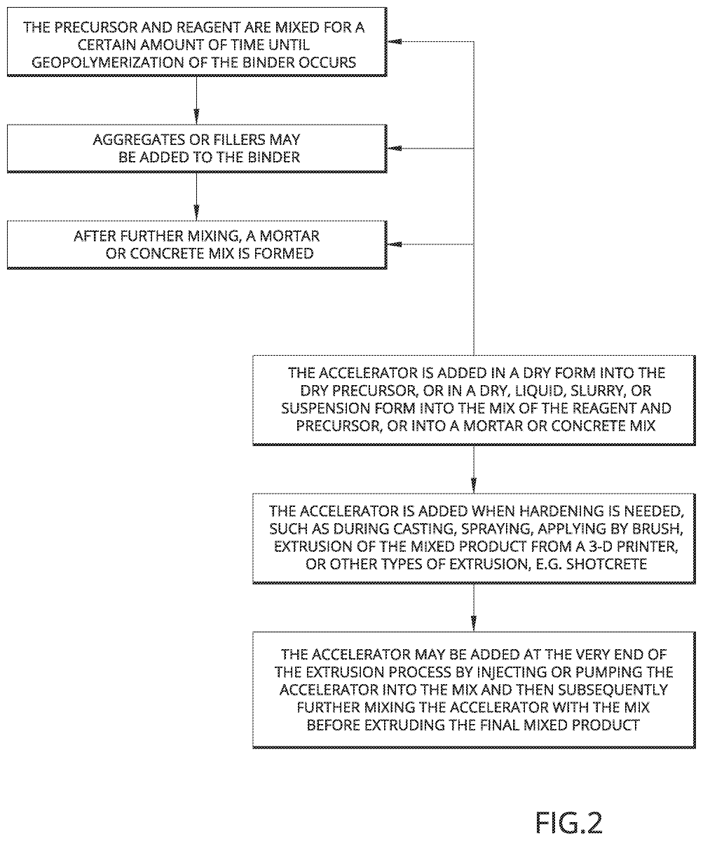

Referring to FIGS. 1 and 2, FIG. 1 illustrates the many points in the production process at which the accelerator may be added. The accelerator may be added to a precursor, which is then mixed with a reagent to produce a binder. The accelerator may be added to a binder. The accelerator may be added to a mortar produced by mixing a binder with aggregate and filler. Moreover, the accelerator may be added to the mortar before or during extrusion or casting.

As disclosed in FIG. 2, regardless of where the aggregate is added. The precursor and reagent are mixed for a certain amount of time until geopolymerization of the binder occurs; aggregates and/or fillers may be added to the binder; and after further mixing, a mortar or concrete mix is formed. The accelerator is added when hardening is needed, such as during casting, spraying, such as shotcrete, applying by brush, or extrusion of the mixed produced from a 3-D printer. The accelerator may be added at the very end of the extrusion process by injecting or pumping the accelerator into the mix and further mixing before extrusion of the final product. The form in which the accelerator is added may be dry when added to a dry precursor, and may be dry, liquid, slurry, or suspension when added to the reagent and precursor mix or the mortar or concrete mix.

It should be understood, of course, that the foregoing relates to exemplary embodiments of the invention and that modifications may be made without departing from the spirit and scope of the invention as set forth in the following claims.

What is claimed is:

1. A method of producing a geopolymer product having accelerated setting at a selected point in production, comprising:
providing a precursor, a reagent, and an accelerator;
mixing the precursor and the reagent for a first time to form a geopolymerized binder;
adding aggregate to the geopolymerized binder;
mixing the aggregate and the geopolymerized binder for a second time until a mortar or concrete paste is formed;
applying the mortar or concrete paste by a step selected from the group consisting of extruding, casting, spraying, and brushing; and
adding the accelerator at a step selected from the group consisting of: providing the precursor; mixing the precursor and the reagent; and applying the mortar or concrete paste;
wherein the step selected for adding the accelerator is a function of selecting a setting time for the geopolymer product.

2. The method of claim 1, wherein the step of adding the accelerator is performed by injecting or pumping the accelerator into the mortar or paste, mixing the accelerator with the mortar or paste, and extruding the mixed accelerator and mortar or paste.

3. The method of claim 1, wherein the accelerator is added in a form selected from the group consisting of: dry, liquid, slurry, and suspension.

4. The method of claim 1, wherein the mixing is performed by gravity flow or by high-speed mixing.

5. The method of claim 1, wherein the aggregate is selected from the group consisting of sands, gravels, fibers, and any combination thereof.

6. The method of claim 5, wherein the sands, gravels, and/or fibers are selected from the group consisting of polypropylene, wood fiber, quartz sand, feldspar sand, Chamotte sand, limestone, granite, basalt, industrial by-products, and any combination thereof.

7. The method of claim 1, wherein the precursor comprises an aluminosilicate composition.

8. The method of claim 1, wherein the reagent comprises a silicate of an alkaline metal or an acid.

9. The method of claim 1, wherein the accelerator comprises one or more of gehlenite, akermanite, belite, alite, monocalcium aluminate, and anorthite.
